(19) United States
(12) Patent Application Publication
(10) Pub. No.: US 2022/0125093 A1
(43) Pub. Date: Apr. 28, 2022

(54) NUTRITIONAL SUPPLEMENTS INCLUDING MEAL REPLACEMENTS AND RELATED METHODS

(71) Applicant: Ohio State Innovation Foundation, Columbus, OH (US)

(72) Inventor: Robert DiSilvestro, Dublin, OH (US)

(21) Appl. No.: 17/570,830

(22) Filed: Jan. 7, 2022

Related U.S. Application Data
(62) Division of application No. 14/070,608, filed on Nov. 4, 2013.
(60) Provisional application No. 61/721,584, filed on Nov. 2, 2012.

(51) Int. Cl. A23L 33/00; A23L 33/16; A23L 33/15; A23L 33/105

(52) U.S. Cl. CPC A23L 33/40; A23L 33/16; A23V 2002/00; A23L 33/105; A23L 33/15

(57) ABSTRACT

A nutritional or dietary supplement composition useful for formulating meal replacements, particularly beverage-based meal replacements. The composition is absorbed well in patients with compromised gastrointestinal absorption status, such as those having undergone bariatric surgery, other gastrointestinal surgery, those undergoing chemotherapy, and those with other gastrointestinal absorption disorders. Moreover, the compositions are nutritious foods for healthy people. Lastly, the compositions are useful for people with insulin disorders, difficulty maintaining healthy body weight, or inflammation-related disorders. Related methods are also provided.

### CROSS-REFERENCE TO RELATED APPLICATIONS

This application is a Divisional of U.S. patent application Ser. No. 14/070,608, filed on Nov. 4, 2013, which in turn claims priority to Provisional Application No. 61/721,584, filed on Nov. 2, 2012. The entire disclosures of the above applications are hereby incorporated herein by reference.

### FIELD OF INVENTION

The present invention relates to a nutritional or dietary supplement composition that strengthens and promotes general health. In particular, those with limited food intake and/or compromised ability to absorb nutrients and therefore at greater risk of developing deficiencies can utilize the nutritional supplements of the present invention. In this regard, the present invention provides a superior nutritional meal replacement for bariatric surgery patients.

### BACKGROUND

Bariatric surgery for weight loss intentionally restricts the volume and function of the digestive system for the purpose of weight loss. For a particular time after bariatric surgery, patients rely heavily on liquid meals, and also use these products to some extent long-term. Often, meal replacement beverages, with protein and some vitamins and minerals are used, in conjunction with separate servings of individual liquid vitamins/and or minerals. Moreover, some patients receive some vitamins as an injection or sublingually. In the event that patients fail to comply with the nutritional regimen, severe nutritional consequences can arise, due to the relative difficulties in addressing any deficits after they occur. Similar problems are present for any patient with restricted food intake and/or compromised absorption of nutrients in the digestive tract, whether due to surgery, chemotherapy, gastrointestinal infections/irritations, or other causes.

Many nutritional supplements are currently on the market as meal replacements, including those under the following brand names: EAS; SlimFast; Optifast; and Medifast. Moreover, the individual ingredients of the present invention are known.

Potassium. Current bariatric meal replacement products typically do not specifically add potassium. This approach produces a product with potassium content far below that recommended even for normal people. This can pose a particularly serious problem after any type of surgery if vomiting occurs frequently. Vomiting can cause potassium depletion even with fairly normal potassium intake (6). Even in the absence of vomiting, marginal potassium deficiency affects blood pressure, mood, bone health, and fatigue resistance (6). In addition, potassium intake is thought to relate to kidney stone risk (6), which may increase after gastrointestinal bypass bariatric surgery (16).

Calcium. Calcium nutriture has been noted as a concern for GI bypass bariatric surgery patients (1-3). Currently, calcium supplements are often recommended for such people, but this requires 2 to 4 pills or capsules per day. Current meal replacement products usually contain calcium, but not enough to meet daily needs. Thus, the supplier companies tend to recommend that their customers also purchase separate calcium supplements. The calcium in the meal replacement products is often calcium carbonate, which does not dissolve well in water and needs stomach acid for absorption (6). The former property does not bode well for putting large amounts in meal replacement products that are taken with water. The latter property poses problems for bariatric surgery patients who do not have normal acid-food mixing.

Vitamin B-12. Vitamin B12 absorption is normally mediated by the protein intrinsic factor by a complicated process (17). This process is disrupted by bariatric surgery (1-4). Currently, deficiency prevention strategies usually involve injections or sublingual administration. These are inconvenient strategies.

Iron. Iron deficiency anemia can occur in good number of people after GI bypass bariatric surgery, especially in premenopausal women (1,2). Reduced iron absorption seems to be a major cause of this anemia. A more moderate, non-anemia iron deficiency can also occur in people (6). This has not been studied extensively in regard to bariatric surgery. However, changes in values for iron status markers without anemia have been noted following bariatric surgery (3). Ferrous sulfate is the usual choice for treating iron deficiency, but it can cause GI tract irritation (6), a big concern for people who have had bariatric surgery. Thus, other forms are used after this surgery, but these forms typically require the person to ingest iron lozenges or multiple pills/capsules per day. Such iron is generally not added to meal replacement products due to taste issues. Alternatively, meal replacement products could contain a form of iron that is tasteless, has low GI tract irritability, and is absorbed well enough to treat or prevent iron deficiency. An example is Albion's Iron Glycinate Chelate Taste Free™.

Copper. Although copper does not receive as much attention as iron for bariatric surgery patients, documented cases of severe copper deficiency have been found regularly in this population (4,7-11). Moreover, evidence exists that the condition has been under diagnosed (4,10,11). Severe cases have been reported to produce neurological problems with metabolic abnormalities that overlap those of vitamin B12 deficiency (10,11). Even without severe copper deficiency, marginal copper deficiency most likely presents a concern. This state occurs very frequently in even relatively healthy people, which means it likely occurs even more frequently with the reduced copper absorption associated with GI bypass bariatric surgery. Most multivitamin-mineral supplements don't help much with copper status since they usually contain the poorly absorbed copper oxide (6). Some bariatric surgery nutritional support products contain copper gluconate. This form has received little human study; two studies that have been done show poor effectiveness (6). In contrast, a number of studies with copper glycinate have shown a good ability to reverse marginal copper deficiency (i.e., 12-14). Copper can also be given with some effectiveness in the sulfate form, but this can produce GI distress symptoms in some people (6).

Vitamins A and D. Absorption of certain lipids can be impaired after bariatric surgery (1-4). For vitamins A and D, a number of studies have shown that after surgery, blood indicators for body status of these vitamins can fall below adequate even with relatively high dose supplementation (i.e., 3,5).

Flavonoids. Nutritional effects on antioxidant capacity involve both essential nutrients and phytochemicals. The latter are plant food components that do not fill essential functional roles, but can exert health promoting actions including antioxidant effects (17). Most meal replacement products of any kind tend to exclude phytochemicals. Maintaining good antioxidant capacities can hold importance after bariatric surgery for promoting good immune function, stimulating wound healing, and reducing inflammation. Body organ integrity and/or function can be protected by phytochemicals during physiological stress to the body. Both the weight loss post-surgery, and the acute and chronic effects of the surgery itself can product physiological stress. In a preliminary study, in people who have had recent bariatric surgery, debittered green tea produced some improvement in a blood indicator for kidney function (DiSilvestro R A, unpublished data). The control group showed no change.

Magnesium. This mineral has not been studied much in regard to bariatric surgery, but stress to the body is thought to raise magnesium requirements (6). Magnesium absorption and side effects, mainly as laxative actions, vary with different forms of magnesium (6). Magnesium glycinate does not exert laxative actions and may show good absorption, though testing of the latter has been limited (6).

Zinc. A research article called zinc deficiency “a frequent and underestimated complication after bariatric surgery” (27). This mineral is included in meal replacement products geared to post-bariatric surgery, but the amounts and forms of zinc have received little attention. For supplements or meal replacement products, if zinc is added, it is usually as zinc gluconate or zinc oxide, which are forms that may not provide optimal absorption or utilization (6). Zinc sulfate can also be chosen and is still prescribed sometimes by physicians for treating severe zinc deficiency (6). However, use of the sulfate complex has fallen in meal replacement products due to sensory issues. This form is also not used much anymore in supplements due to the potential for GI tract upset. Alternatively, zinc glycinate could be used since it has produced good effects in some human studies (6). However, zinc glycinate has not been compared directly much to other forms of zinc in human studies.

Previously-available meal replacements comprise different formulations from the present invention. Moreover, the present formulation provides surprising results compared to other meal replacements, particularly in those with compromised ability to absorb nutrients and/or in those with increased risk of nutrient deficiency.

### BRIEF DESCRIPTION OF THE FIGURES

FIG. 1. Antioxidant status (serum free radical scavenging capacity) in rats fed a low phytochemical diet (control) or the same diet+a green tea flavonoid preparation. Units are Trolox equivalents. *Significantly different from pre values, p<0.005, paired t-test.

FIG. 2. Rise in red blood cell zinc in young adult women comparing zinc glycinate (chelate), zinc oxide, and gluconate.

### SUMMARY OF THE INVENTION

These and other objectives and advantages of the present invention, some of which are specifically described and others that are not, will become apparent from the detailed description and claims that follow.

The present invention provides nutrition supplement compositions comprising on a daily dosage basis: approximately 1 to 3 g potassium, approximately 600 to 1500 mg calcium, approximately 300 to 1500 micrograms vitamin B-12, approximately 30 to 90 mg iron, approximately 1 to 3 mg copper, approximately 400 to 2400 IU vitamin D, approximately 2000 to 6000 IU vitamin A, and approximately 500 to 1500 mg flavonoids.

The present invention also provides nutrition supplement compositions comprising on a daily dosage basis: approximately 1 to 2 g potassium, approximately 700 to 1300 mg calcium, approximately 900 to 1200 micrograms vitamin B-12, approximately 40 to 60 mg iron, approximately 2 to 3 mg copper, approximately 1000 to 1500 IU vitamin D, approximately 2500 to 3500 IU vitamin A, and approximately 600 to 800 mg flavonoids.

The present invention also provides nutrition supplement compositions comprising on a daily dosage basis: approximately 1.3 g potassium, approximately 1100 mg calcium, approximately 1000 micrograms vitamin B-12, approximately 50 mg iron, approximately 2.5 mg copper, approximately 1200 IU vitamin D, approximately 3000 IU vitamin A, and approximately 700 mg flavonoids.

In particular, such compositions are provided which comprise potassium gluconate, calcium lactate, methylcobalamin, tasteless iron, copper glycinate, vitamin D, vitamin A, and debittered green tea extract.

In particular, such compositions are provided which further comprise at least one protein selected from the group consisting of: whey protein extract, whey protein isolate, whey protein hydrosylate; whey protein concentrate, soy isolate, and casein.

In particular, such compositions are provided which further comprise an unflavored protein.

In particular, such compositions are provided which comprise an amount of unflavored protein selected from the group consisting of: 5 to 80 g per daily dose; 30 to 70 per daily dose; approximately 54 grams per daily dose.

In particular, such compositions are provided which further comprise at least one fiber selected from the group consisting of: polydextrose; microcellulose; microground fiber; inulin; and soluble grain dextrin.

In particular, such compositions are provided which further comprise soluble wheat dextrin.

In particular, such compositions are provided which further comprise a Nutriose® product from Roquette Corporation.

In particular, such compositions are provided which further comprise an amount of a soluble wheat dextrin selected from the group consisting of: 5 to 25 grams per daily dose; 8-15 grams per daily dose; approximately 10 grams per daily dose.

In particular, such compositions are provided which further comprise magnesium glycinate.

In particular such compositions are provided which further comprise zinc glycinate.

In particular, such compositions are provided which further comprise one or more of a nutrient selected from the group consisting of: vitamin C, coenzyme Q, manganese as manganese glycinate, lutein, zeaxanthin, lutein-zeaxanthin, beta carotene, quercetin, phenolic compounds, lipoic acid, taurine, fish oil, and anthocyanosides.

In particular, such compositions are provided in an oral nutrition delivery vehicle selected from the group consisting of: tablet, capsule, food, and drink.

In particular, such compositions are provided which are formulated for a mammal selected from the group consisting of horse, dog, cat, cattle and human.

In particular, such compositions are provided wherein the vehicle for oral nutrition delivery is a beverage.

Also provided by the present invention are methods of manufacturing a composition herein, comprising: blending a composition of any claim herein into a liquid vehicle for oral nutrition delivery.

Also provided by the present invention are methods of providing nutrients to a gastrointestinal absorption-compromised patient, comprising administering a composition herein to a gastrointestinal absorption-compromised patient.

Also provided by the present invention are methods of ameliorating nutrient loss in a patient after bariatric surgery, comprising administering a composition herein to a patient after bariatric surgery.

Also provided by the present invention are methods of providing nutrients to a patient after bariatric surgery, comprising administering a composition herein to a patient after bariatric surgery.

Also provided by the present invention are methods of providing nutrients to a chemotherapy patient, comprising administering a composition herein to a chemotherapy patient.

Also provided by the present invention are methods for providing nutrients to a gastrointestinal absorption-compromised patient, wherein the gastrointestinal absorption-compromised patient has a condition selected from the group consisting of: crohn's disease, diverticultis, ulcerative colitis, irritable bowel syndrome, cystic fibrosis, cancer patient, fat malabsorption, a patient who has had their stomach removed, and a patient who has had large or small intestine removed.

Also provided by the present invention are methods providing nutrients to a person, comprising administering a composition herein to a person.

In particular, such methods are provided, wherein the person is desirous of reducing body weight.

In particular, such methods are provided, wherein the person is overweight or obese, including those who follow medically-supervised programs of limited food intake or severe diet restriction, such as the Optifast® VLCD™ Program.

In particular, such methods are provided, wherein the person has diabetes.

In particular, such methods are provided, wherein the person has a condition selected from the group consisting of: syndrome X, blood sugar dysregulation, high body fat percentage, metabolic syndrome, polycystic ovarian syndrome, fibromyalgia, chronic fatigue syndrome, risk of heart disease, heart disease, inflammation, risk of stroke, stroke, high fasting blood sugar, high visceral body fat, low HDL cholesterol level, smoker, high blood pressure, poor diet, high triglyceride levels, lack of physical activity, pancreatic compromise, insulin resistance, viral infection, and malaise.

### DETAILED DESCRIPTION

The following detailed description is provided to enable any person skilled in the art to which the present invention pertains to make and use the same, and sets forth the best mode contemplated by the inventors of carrying out the subject invention.

Compositions

Specific nutrients in combination have been shown to be superior than prior formulations in absorption-compromised patients.

Table 1 describes ranges for each nutrient in weight or IU, along with embodiment forms. Weights for minerals are given for the mineral only, not the weight of the entire mineral complex. Each range of the composition nutrients is independent from the ranges of the other indicated nutrients. For instance, in devising a formulation from Table 1, potassium may be selected from the range indicated in Range 1, calcium may be selected from the range indicated in Range 3, iron may be selected from the range indicated in Range 2 and methylcobalamin may be selected from the range indicated in Range 1. Moreover, some nutrients may be omitted, and some other nutrients, such as protein and fiber, may be added.

TABLE 1
Daily Dosage, by weight

| Nutrient | Embodiment Form | Range 1 | | Range 2 | | Range 3 |
|---|---|---|---|---|---|---|
| Potassium | potassium gluconate | 1-3 | grams | 1-2 | grams | Approx. 1.3 grams |
| Calcium | calcium lactate | 600-1500 | mg | 700-1300 | mg | Approx. 1100 mg |
| Vitamin B-12 | Methylcobalamin | 300-1500 | micrograms | 900-1200 | micrograms | Approx. 1000 micrograms |
| Iron | Tasteless iron | 30-90 | mg | 40-60 | mg | Approx. 50 mg |
| Copper | copper glycinate | 1-3 | mg | 2-3 | mg | Approx. 2.5 mg |
| Vitamin D | vitamin D | 400-2400 | IU | 1000-1500 | IU | Approx. 1200 IU |
| Vitamin A | vitamin A | 2000-6000 | IU | 25200-3500 | IU | Approx. 3000 IU |
| Flavonoids | green tea extract | 500-1500 | mg | 600-800 | mg | Approx. 700 mg |
| | (debittered) | | | | | |
| Fiber | Wheat dextrin fiber | 5-20 | g | 8-15 | g | Approx. 10 g |
| Magnesium | magnesium glycinate | 250-600 | mg | 300-500 | mg | Approx. 400 mg |
| Zinc | Zinc glycinate | 7-50 | mg | 15-50 | mg | Approx. 15 mg |

This weight percentage for nutrients may represent approximately a twenty-five to sixty percent overage in the delivery vehicle formulation to ensure product potency over the shelf life of the delivery vehicle.

The above formulation in Table 1 may be used in a meal replacement formulation. Meal replacements in the form of a beverage are one embodiment. In a meal replacement formulation, the daily dosages would ideally be divided approximately equally amongst the number of servings per day. In other words, if, for example, two beverages per day are preferred, then the daily dosage in Table 1 would be divided equally between the two beverages. If three beverages are preferred, then the daily dosage in Table 1 would be divided by thirds, with a third of each nutrient being present in each of the three beverages. Moreover, additional nutrients would optimally be provided if the formulation of Table 1 is used as a meal replacement.

A meal replacement would optimally provide a protein source and a fiber source. Ideally, the protein and fiber sources present sensory profiles to enhance compliance.

Acceptable protein sources in the present invention include, without limitation: soy protein, casein, and/or whey protein, including preparations of whey protein which may range from about 1% to about 99% whey protein. Whey protein preparations may be in an aqueous form created by the removal of casein, but often takes several other forms, such as, for example, but not by way of limitation, a whey protein extract, whey protein concentrate, whey protein isolate, or whey protein hydrolysate, or any combination thereof. Other sources include: lactalbumin, serum albumin, glycomacropeptide, soy protein, rice protein, pea protein, canola protein, wheat protein, hemp protein, zein, flax protein, egg white protein, ovalbumin, or gelatin protein.

Acceptable fiber sources in the present invention include, without limitation: polydextrose, microcellulose, microground fiber, inulin, soluble grain dextrin, including wheat dextrin, particularly a Nutriose® product, or any combination thereof. Such a fiber may have good effects on blood sugar and possibly enhance weight loss.

Sweeteners increase sensory appeal and therefore compliance of a meal replacement embodiment, and are therefore optionally provided in a meal replacement herein. For calorie-restricted or diabetic meal replacements, at least one, or a combination of, reduced-calorie sweeteners may be used, such as sucralose, saccharine, aspartame or stevia. For those meal replacements where calories are either a benefit or neutral, sweeteners with calories may be used. Such sweeteners may include one or more of the following: sucrose, dextrose (glucose), fructose, lactose, corn syrup, high fructose corn syrup, molasses, cane sugar extract, sugar beet extract, honey, or any combination thereof. Moreover, a combination of caloric- and non-caloric sweeteners may be utilized.

High-absorption forms of Vitamins A and/or D may be used.

The invention is further directed to a meal replacement beverage having a novel composition which, when blended with an ingestible liquid, such as water or milk, produces a highly palatable, highly nutritious instant shake. Another object of the invention is to provide an improved weight control product, which is readily and conveniently employed such as by the blending of the same with water, milk, or other ingestible liquid, prior to the ingesting of the blended product. Alternatively, the composition can be already mixed with an ingestible liquid and provided to a consumer already prepared.

Acceptable liquid for use in the present invention include, without limitation: cow milk (skim, part-skim, whole, cream-enriched), goat milk, sheep milk, vegetable milk substitutes (soy, rice, almond, other nut milks), water, juice; nectars; and any combination thereof. In one embodiment, water is the liquid.

Meal replacements comprising the present invention have the following advantages, inter alia:

A single meal replacement product can be used instead of the combination of meal replacement product plus supplements as capsules, tablets, pills, injections, or preparations that are used sublingually.

A number of nutrients will be delivered in an amount and/or form that should produce greater amounts absorbed than obtained from standard formulations.

The new meal replacement product has added potassium, which is not typically added to current bariatric meal replacement products; the new addition could produce multiple benefits including decreased risk of post-surgery kidney stones.

The new meal replacement product has added phytochemicals (plant derived chemicals that are not strictly required for normal body function, but which can promote health); phytochemicals are not generally added to current bariatric meal replacement products; the new addition could produce multiple benefits including improved antioxidant/anti-inflammatory actions and cardiovascular protection.

Using soluble dextrin as the dietary fiber is particularly well suited for promoting satiety and good blood sugar readings when combined with the nutrients in Table 1.

The chosen forms for many of the ingredients allow putting relatively large amounts into a single serving. These additions are accomplished while still maintaining good water solubility and without producing taste problems. Generally, customers may use two servings per day of the product to eliminate the need for supplement capsules, pills, lozenges, or injections. This may apply even to people who have higher than normal needs due to bariatric surgery or other medical conditions. The exception to this one-stop shopping approach may be subjects with especially severe nutritional problems.

Using an unflavored protein as the protein base that has superior sensory qualities when combined with the nutrients in Table 1 can increase compliance. The unflavored protein may have a bland taste but good taste when flavor is added, and high water solubility.

The magnesium may be a form with high absorption, low laxative tendencies, little or no taste, and high water solubility. In one embodiment, the magnesium may be magnesium glycinate.

The zinc may be a form with high absorption, limited tendencies to degrade other ingredients present, and limited tendency to induce GI tract distress. In one embodiment, the zinc may be zinc glycinate.

The ingredients of this product do not have the bitter, metallic, or salty tastes that can be produced by other forms of some of the included ingredients; this reduces or eliminates the need for major taste masking.

Optional Ingredients

Other ingredients may likewise be added to the nutritional or dietary composition of the present invention if desired. Such ingredients include for example but are not limited to flavorants, plant extracts, carbonation, fats and fatty acids, carbohydrates, enzymes, stimulants (eg. caffeine), relaxants (eg. melatonin), and other vitamins and minerals.

As noted above, inactive ingredients well known in the art may be present in the formulation, to aid in manufacturing the subject composition. For example, inactive ingredients may include but are not limited to antimicrobials (eg. natamycin, nicin), binders, lubricants and disintigrants such as for example cellulose, gelatin, magnesium stearate, water, vegetable oil, glycerin, beeswax and silica. Coloring agents may be added. Agents such as citric acid, fumaric acid, adipic acid, tartaric acid, and in some instances lactic acid may be added to adjust for tartness.

Methods of Manufacturing, Formulating and Delivering

A method of manufacturing the nutritional or dietary supplement composition of the present invention includes providing the base ingredients in accordance with the formulation noted above. The base ingredients of the subject composition, as well as any desired inactive ingredients and/or additive ingredients are combined by weight as described above and mechanically combined, such as for example, through the use of a blender to form a blend. If necessary, the blend is then tumbled until uniform. The blend is then packaged as a powder or formed into capsules or tablets. Optionally, ingredients to decrease clumping may be added to the composition. Alternatively, the blend may be placed in a food oil to form a slurry for containment in a soft gel capsule or for oral administration.

The subject composition is formulated to provide the above-listed base ingredients at preferably (but not necessarily) not less than the daily dosage amounts specified above. This particular formulation of the subject composition has unexpectedly been shown to provide a greater nutrient absorption profile than that achieved through the administration of a commercially-available meal replacement product. The subject composition may be provided for oral administration in the form of at least one beverage per day, or two beverages per day.

Beverages comprising the subject composition contain larger quantities of base ingredients per day than the minimum quantities per day specified above. The minimum quantities specified above, per day, reflect the minimum amount of each base ingredient to be provided upon oral administration through to the date of beverage expiration as set forth on the beverage sale label. However, since base ingredients are subject to degradation over time, the beverages must contain larger quantities of base ingredients to compensate for ingredient degradation. By providing larger quantities of base ingredients in each beverage, one is ensured that even with ingredient degradation, one hundred percent of the ingredient amount specified on the beverage sale label is provided upon oral administration of the beverage through to the specified expiration date of the beverage. Another consideration in formulating the subject composition is that depending on the source of the individual ingredients, individual ingredient degradation rates may vary.

Variations contemplated in administering the subject composition to humans or other animals include, but are not limited to, providing time-release tablets or tablets manufactured to be administered as a single dose or as other multiple part dosages. Additionally, alternative avenues of administration besides oral administration are contemplated herein such as for example, but not limited to, intraperitoneal, intravenous, subcutaneous, sublingual, transcutaneous, intramuscular or like forms of administration.

For instance, the composition may appear, for example, in the form of all kinds of food, feed, drink, functional food and functional feed, e.g. as bread, cookies and biscuits, cheese and other dairy products, chocolate, jam, pudding and other dairy desserts, spreadable products, frozen desserts and ice-cream; in the form of a pharmaceutical composition and medicament, e.g. as a powder, an aggregate, a granulate, a tablet, a coated tablet, a lozenge, a capsule, a drink, a syrup, a composition for tube feeding, for enteral intake, for oral administration and for enteral administration.

The composition may be useful as a supplement for any animal susceptible to absorption problems, including, for example, horses, dogs, cats, cattle, and humans.

The composition may be used by individuals who are overweight and often an immediate health risk of obesity (and who often may get bariatric surgery). The composition may be used by such individuals as part of a fasting or semi-fasting program, which may be under medical supervision.

While there is described herein certain specific embodiments of the present invention, it will be manifest to those skilled in the art that various modifications may be made without departing from the spirit and scope of the underlying inventive concept and that the same is not limited to the particular forms herein described except insofar as indicated by the scope of the appended claims.

### REFERENCES

1. Bloomberg R D, Fleishman A, Nalle J E, Herron D M, Kini S (2005) Nutritional deficiencies following bariatric surgery: what have we learned? Obes Surg 15:145-154.
2. Song A, Fernstrom M H (2008) Nutritional and psychological considerations after bariatric surgery. Aesthetic Surg 28:195-199.
3. Toh S Y, Zarshenas N, Jorgensen J (2009) Prevalence of nutrient deficiencies in bariatric patients. Nutrition 25:1150-1156.
4. von Drygalski A, Andris D A (2009) Anemia after bariatric surgery: more than just iron deficiency. Nutr Clin Pract 24:217-226.
5. Nelson M L et al (2007) Correction of preoperative vitamin D deficiency after Roux-en-Y gastric bypass surgery. Surg Obes Rel Dis 3:434-437.
6. DiSilvestro R A (2005) Handbook of Minerals as Nutritional Supplements, CRC Press, Boca Raton.
Nielsen F, Lukaski H, Johnson L, Roughead Z (2011) Reported zinc, but not copper, intakes influence whole-body bone density, mineral content and T score responses to zinc and copper supplementation in healthy postmenopausal women. British Journal of Nutrition 106:1872-1879.
7. Kumar N, Burtz J A, Burrit M F (2007) Clinical significance e of the laboratory determination of low serum copper in adults. Clin Chem Lab Med 45:1402-1410.
8. Kumar N, Ahlskog J E, Gross Jr J B (2004) Acquired hypocupremia after gastric surgery. Clin Gastroenterol Hepatol 2:1074-1079.
9. Kelkar P, Chang S, Muley S A (2008) Response to oral supplementation in copper deficiency myeloneuropathy. J Clin Neuromuscul Dis 10:1-3.
10. Griffith D P, Liff D A, Ziegler T R, Esper G J, and Winton E (2009) Acquired copper deficiency: a potentially serious and preventable complication following gastric bypass surgery. Obesity 17:827-831.
11. Kumar N, Gross J B Jr, Ahlskog J E (2004) Copper deficiency myelopathy produces a clinical picture like subacute combined degeneration. Neurology 63:33-39.
12. DiSilvestro R A, Selsby J, Siefker K (2010) Copper supplementation effects on plasma F2αisoprostanes and urinary collagen crosslinks in young adult women. J Trace Elem Med Biol 24:165-168.
13. Jones A A, DiSilvestro R A, Coleman M, Wagner T L (1997) Copper supplementation of adult men: effects on blood copper enzyme activities & indicators of cardiovascular disease risk. Metabolism 46:1380-1383.
14. Kehoe C A, Turley E, Bonham M P, O'Connor J M, McKeown A, Faughnan M S, Coulter J S, Gilmore W S, Howard A N, Strain J J. (2000) Response of putative indices of copper status to copper supplementation in human subjects. Br J Nutr 84: 151-156.
15. Okuda K; Yashima K, Kitazaki T, Takara I (1973) Intestinal absorption and concurrent chemical changes of methylcobalamin. J Lab Clin Med 81:557-567.
16. Asplin J R, Coe F L (2007) Hyperoxaluria in kidney stone formers treated with modern bariatric surgery. J Urol 177:565-569.
17. Wardlaw G M, Hampl J S, DiSilvestro R A (2004) Perspectives in Nutrition, 6th ed., McGraw Hill, New York.
18. DiSilvestro R A, Blostein-Fujii A, Watts B (1999) Low phytonutrient, semipurified liquid diets depress plasma total antioxidant status in renal dialysis patients. Nutr Res 19:1173-1177.
19. Hansson G (2005) Inflammation, Atherosclerosis, and Coronary Artery Disease. New Eng J Med 352:1685-1695.
20. Vázquez L A, Pazos F, Berrazueta J R, Fernández-Escalante C, Garcia-Unzueta M T, Freijanes J, Amado J A (2005) Effects of changes in body weight and insulin resistance on inflammation and endothelial function in morbid obesity after bariatric surgery. J Clin Endocrinol Metab 90:316-322.
21. Christakos S, Dhawan P, Benn B, Porta A, Hediger M, Oh G T, Jeung E B, Zhong Y, Ajibade D, Dhawan K, Joshi S (2007) Vitamin D: molecular mechanism of action. Ann NY Acad Sci 1116:340-348.
22. Riedl M, Vila G, Maier C, Handisurya A, Shakeri-Manesch S, Prager G, Wagner O, Kautzky-Willer A, Ludvik B, Clodi M, Luger A (2008) Plasma osteopontin increases after bariatric surgery and correlates with markers of bone turnover but not with insulin resistance. J Clin Endocrinol Metab 93:2307-2312.
23. Allen L H (2009) How common is vitamin B-12 deficiency? Am J Clin Nutr 89:6935-696S.
24. Serić V, Dutour-Sikirić M, Mihaljević I, Tucak-Zorić S, Bilić-Curcić I, Babić-Ivancić V (2009) Metabolic and physico-chemical urolithiasis parameters in the first morning urine. Coll Antropol 33:85-92.
25. Ogawa Y, Yonou H, Hokama S, Oda M, Morozumi M, Sugaya K (2003) Urinary saturation and risk factors for calcium oxalate stone disease based on spot and 24-hour urine specimens. Front Biosci 8:a167-a176.
26. Aasheim E, Bjorkman S, Bøhmer T, et al (2009) Vitamin status after bariatric surgery: a randomized study of gastric bypass and duodenal switch. American J Clin Nutr 90:15-22.
27. Sallé A, Demarsy D, Poirier A L, Lelièvre B, Topart P, Guilloteau G, Bécouarn G, Rohmer V (2010) Zinc deficiency: a frequent and underestimated complication after bariatric surgery. Obesity Surgery 20:1660-1670.

### EXAMPLES

### Example 1

Antioxidant Status Improves in Rats Fed a Green Tea Flavonoid Preparation

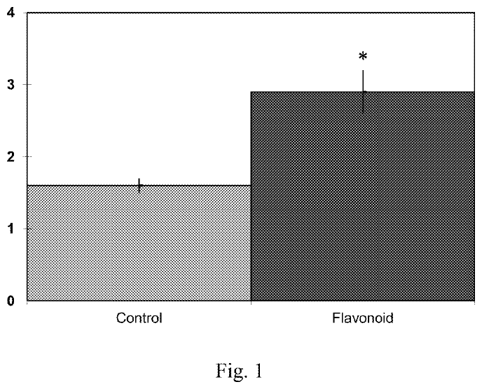

Rats were fed a semi-purified, phytochemical-free diet for 4 weeks. Antioxidant status showed much higher values in rats given a green tea flavonoid phytochemical preparation versus rats fed the diet alone (FIG. 1). This result reinforces the concept that in humans, adding phytochemicals to a meal replacement product can produce health benefits.

### Example 2

Bariatric Surgery for Weight Loss Formulation Having Superior Results

Design. Young adult females who were about to have bariatric surgery were recruited. Blood and urine samples were taken before surgery and 6 weeks later. People were divided into two groups. One group drank 2 servings per day of the new product related to this patent (N=12) for 6 weeks. The other group drank 2 servings of a current meal replacement product and also took other supplements including sublingual vitamin B12. The new product had the B12 put right in the meal replacement product. The vitamin is put in the product at a daily dose that is very high relative to normal recommendations, and high relative to what was used for injections or sublingual administration. Also, a coenzyme form of the vitamin was used in the meal replacement product.

Results. Similar values for a plasma marker of B12 status were found in both groups. This supports the concept that the new meal replacement product can work well without generally needing additional supplement products.

Copper status showed a difference for people drinking the new product versus people using conventional products. Copper intake was similar for both groups in terms of quantity, but the new formulation used copper glycinate instead of other forms. Copper status was assessed by plasma concentrations of ceruloplasmin, a protein that generally contains about 95% of the copper in plasma (6). Values fell in people taking the competitor's product, but not in people consuming the new formulation. Results were as follows:

TABLE 2

| | Conventional Products | New Formulations |
|---|---|---|
| Pre-Surgery | 371 ± 34 | 355 ± 28 |
| 6 Week Post-Surgery | 331 ± 22* | 369 ± 24 |

Values are mg ceruloplasmin/1 of plasma, mean ± SEM (N = 12 per group)
*Significantly different from Pre-value, p < 0.05, paired T-test; also, the change in values were significantly different for the new formulations versus Bariatric Advantage, p < 0.05, unpaired T-test

Adding Albion's Iron Glycinate Chelate Taste Free™ to a meal replacement product improved iron status to about the same degree as a conventional bariatric meal replacement product+iron lozenges (same amount of iron for each group). Iron status was measured as ferritin/CRP ratios (ferritin reflects iron status but can also be influenced by inflammation; CRP only reflects inflammation).

TABLE 3

| Conventional Products | New Formulation |
|---|---|
| 5.9 ± 1.0 | 9.8 ± 3.2 |
| 14.9 ± 1.0 | 21.3 ± 9.9 |

Values are the ratio means ± 12/group;
Mean increases did not differ between groups

Adding a fiber called Nutriose® to the new formulation resulted in a lowering of fasting blood sugar. This effect was not seen with conventional products with the same amount of fiber. Results were as follows:

TABLE 4

| | Conventional Products | New Formulations |
|---|---|---|
| Pre-Surgery | 151 ± 16 | 111 ± 8 |
| 6 Week Post-Surgery | 150 ± 20* | 101 ± 8* |

Values are mg glucose/dl of plasma, mean ± SEM, N = 12/group
*Significantly different from Pre-value, p < 0.05, paired T-test

Plasma magnesium concentrations rose with use of the new formulation, but not with the conventional products. The percent rise was not large, but plasma magnesium values tend not to change much even with improved magnesium status (6). The results were as follows:

TABLE 5

| Conventional Products | New Formulation |
|---|---|
| 27.0 ± 0.9 | 27.6 ± 1.0 |
| 27.3 ± 1.3 | 29.8 ± 1.9* |

Values are mg magnesium/ml of plasma, mean ± SEM, N = 12/group
*Significantly different from Pre-value, p < 0.05, paired T-test

### Example 3

Optimization for Particular Purposes. The Procedures Above Will be Completed for Various Specialty Patients

A. Bariatric patients for weight gain

B. Chemotherapy patients

C. Other absorption-compromised patients (Crohn's, diverticulitis, IBS, infection, people on programs such as the Optifast® VLCD™ Program, etc.)

### Example 4

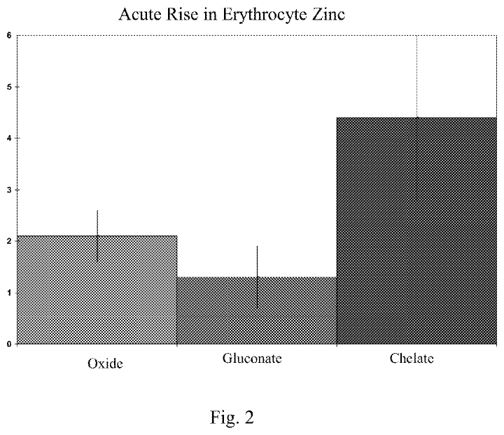

Zinc glycinate has not been studied at all in people who have had bariatric surgery. Furthermore, in published studies on any types of people, zinc glycinate has not been compared much to other forms of zinc. Thus, an unpublished comparative study was done in healthy young adult women that compared zinc glycinate to two other forms of zinc. The study utilized an indirect approach of absorption. In this approach, a single dose of zinc was given to young adult women; blood was taken at 0, 1, 2, 3, and 4 hours. Both plasma and red blood cells (erythrocytes) were analyzed for zinc and for each, an area under the curve graph was calculated for zinc content versus time. Zinc glycinate outperformed zinc oxide and gluconate for both plasma and erythrocyte. The later data is shown in FIG. 2, where the area under the curve shows rise in red blood cell zinc from time zero versus 1, 2, 3, and 4 hours after a single dose of zinc in young adult women, and where chelate is Albion's zinc glycinate.

What is claimed is:

1. A method of providing nutrients to a person without producing taste problems, the method comprising steps of:
providing a serving of a beverage composition including
ingestible liquid,
protein in an amount from 10 grams and 40 grams,
potassium gluconate in an amount sufficient to provide from 0.5 grams to 1.5 grams of elemental potassium, and
dietary fiber in an amount from 3 grams to 14 grams, wherein the dietary fiber is selected from the group consisting of: polydextrose, microcellulose, microground fiber, inulin, soluble grain dextrin, soluble wheat dextrin, and Nutriose® soluble dextrin; and
orally administering to the person the serving of the beverage composition twice daily, wherein a size of the serving is about 8-fluid ounces, whereby the beverage composition provides a supplemental amount of the elemental potassium as one of the nutrients and does not taste bitter, metallic, or salty to the person upon being administered the serving.

2. The method of claim 1, wherein the serving of the beverage composition further includes vitamin D in an amount of from 600 IU to 1200 IU, whereby the beverage composition provides a supplemental amount of the vitamin D as one of the nutrients.

3. The method of claim 1, wherein the serving of the beverage composition further includes water insoluble ferric triglycinate in an amount sufficient to provide from 15 mg to 45 mg of elemental iron, and the protein is provided in the form of a protein powder, whereby the beverage composition provides a supplemental amount of the elemental iron as one of the nutrients.

4. The method of claim 1, wherein the serving of the beverage composition further includes a copper ingredient in an amount sufficient to provide from 0.5 mg to 1.5 mg of elemental copper, whereby the beverage composition provides a supplemental amount of the elemental copper as one of the nutrients.

5. The method of claim 4, wherein the copper ingredient is copper glycinate.

6. The method of claim 1, wherein the serving of the beverage composition further includes a zinc ingredient in an amount sufficient to provide from 5 mg to 25 mg of elemental zinc, whereby the beverage composition provides a supplemental amount of the elemental zinc as one of the nutrients.

7. The method of claim 6, wherein the zinc ingredient is zinc glycinate.

8. The method of claim 1, wherein the serving of the beverage composition further includes a magnesium ingredient in an amount sufficient to provide from 200 mg to 300 mg of elemental magnesium, whereby the beverage composition provides a supplemental amount of the elemental magnesium as one of the nutrients.

9. The method of claim 8, wherein the magnesium ingredient is magnesium glycinate.

10. The method of claim 1, wherein the serving of the beverage composition further includes a calcium ingredient in an amount sufficient to provide from 300 mg to 750 mg of elemental calcium, whereby the beverage composition provides a supplemental amount of the elemental calcium as one of the nutrients.

11. The method of claim 10, wherein the calcium ingredient is calcium lactate.

12. The method of claim 1, wherein the serving of the beverage composition further includes a vitamin B12 ingredient in an amount sufficient to provide from 150 mcg to 750 mcg of the vitamin B12, whereby the beverage composition provides a supplemental amount of the vitamin B12 as one of the nutrients.

13. The method of claim 1, wherein the serving of the beverage composition further includes an antioxidant ingredient in an amount sufficient to provide from 250 mg to 750 mg of flavonoids, whereby the beverage composition provides a supplemental amount of the flavonoids as one of the nutrients.

14. The method of claim 13, wherein the antioxidant ingredient is debittered green tea extract.

15. The method of claim 1, wherein the beverage composition does not contain any taste maskers.

16. The method of claim 1, wherein the person is chosen from a group consisting of: a gastrointestinal absorption-compromised patient; a bariatric surgery patient; a chemotherapy patient; a person desirous of reducing body weight; an overweight or obese person; and a person having diabetes, and wherein the person has a condition selected from the group consisting of: severe diet restriction, Crohn's disease, diverticultis, ulcerative colitis, irritable bowel syndrome, cystic fibrosis, fat malabsorption, cancer patient, a patient who has had their stomach removed, and a patient who has had large or small intestine removed.

17. The method of claim 16, wherein the beverage composition is administered to the person after bariatric surgery.

18. A method of providing nutrients to a person without producing taste problems, the method comprising steps of:
providing a serving of a beverage composition including
ingestible liquid,
protein in an amount from 10 grams and 40 grams,
water insoluble ferric triglycinate in an amount sufficient to provide from 15 mg to 45 mg of elemental iron, and
dietary fiber in an amount from 3 grams to 14 grams, wherein the dietary fiber is selected from the group consisting of: polydextrose, microcellulose, microground fiber, inulin, soluble grain dextrin, soluble wheat dextrin, and Nutriose® soluble dextrin; and
orally administering to the person the serving of the beverage composition twice daily, wherein a size of the serving is about 8-fluid ounces, whereby the beverage composition provides a supplemental amount of the elemental iron as one of the nutrients and does not taste bitter, metallic, or salty to the person upon being administered the serving.

19. A method of providing nutrients to a person without producing taste problems, the method comprising steps of:
providing a serving of a beverage composition including
ingestible liquid,
protein in an amount from 10 grams and 40 grams,
vitamin D in an amount of from 600 IU to 1200 IU,
magnesium glycinate in an amount sufficient to provide from 200 mg to 300 mg of elemental magnesium, and
dietary fiber in an amount from 3 grams to 14 grams, wherein the dietary fiber is selected from the group consisting of: polydextrose, microcellulose, microground fiber, inulin, soluble grain dextrin, soluble wheat dextrin, and Nutriose® soluble dextrin; and
orally administering to the person the serving of the beverage composition twice daily, wherein a size of the serving is about 8-fluid ounces, whereby the beverage composition provides a supplemental amount of each of the vitamin D and the elemental magnesium as the nutrients and does not taste bitter, metallic, or salty to the person upon being administered the serving.

20. A method of providing nutrients to a person without producing taste problems, the person chosen from a group consisting of a gastrointestinal absorption-compromised patient, a bariatric surgery patient, a chemotherapy patient, a person desirous of reducing body weight, an overweight or obese person, and a person having diabetes, the method comprising steps of:
providing a serving of a beverage composition including
ingestible liquid,
protein in an amount from 10 grams and 40 grams, wherein the protein is provided in the form of a protein powder,
potassium gluconate in an amount sufficient to provide from 0.5 grams to 1.5 grams of elemental potassium, and
dietary fiber in an amount from 3 grams to 14 grams, wherein the dietary fiber is selected from the group consisting of: polydextrose, microcellulose, microground fiber, inulin, soluble grain dextrin, soluble wheat dextrin, and Nutriose® soluble dextrin,
vitamin D in an amount from 600 IU to 1200 IU,
water insoluble ferric triglycinate in an amount sufficient to provide from 15 mg to 45 mg of elemental iron,
a copper ingredient in an amount sufficient to provide from 0.5 mg to 1.5 mg of elemental copper,
a zinc ingredient in an amount sufficient to provide from 5 mg to 25 mg of elemental zinc,
a magnesium ingredient in an amount sufficient to provide from 200 mg to 300 mg of elemental magnesium,
a calcium ingredient in an amount sufficient to provide from 300 mg to 750 mg of elemental calcium,
a vitamin B12 ingredient in an amount sufficient to provide from 150 mcg to 750 mcg of the vitamin B12,
an antioxidant ingredient in an amount sufficient to provide from 250 mg to 750 mg of flavonoids, and
wherein the beverage composition does not contain any taste maskers; and
orally administering to the person the serving of the beverage composition twice daily, wherein a size of the serving is about 8-fluid ounces, whereby the beverage composition provides a supplemental amount of each of the elemental potassium, the vitamin D, the elemental iron, the elemental copper, the elemental zinc, the elemental magnesium, the elemental calcium, the vitamin B12, and the flavonoids as the nutrients and does not taste bitter, metallic, or salty to the person upon being administered the serving.
